(19) United States
(12) Patent Application Publication
(10) Pub. No.: US 2023/0116613 A1
(43) Pub. Date: Apr. 13, 2023

(54) MULTIPLE TRANSFERS OF BLOCKCHAIN-BASED TOKENS

(71) Applicant: Vivid Seats LLC, Chicago, IL (US)

(72) Inventor: Jonathan M. Wagner, Audubon, PA (US)

(21) Appl. No.: 17/499,784

(22) Filed: Oct. 12, 2021

(51) Int. Cl. G06Q 20/06; G06Q 20/10

(52) U.S. Cl. CPC G06Q 20/065; G06Q 20/108; G06Q 2220/00

(57) ABSTRACT

Among other things, we describe implementations of systems and methods for enabling one or more nodes of an electronic ledger platform to carry out operations with respect to one or more records in the electronic ledger platform. The operations include receiving an indication authorized by an entity to transfer a token to another entity, the indication comprising a first quantity of cryptocurrency to be provided by the entity, the token comprising a record of a record of a second quantity of cryptocurrency provided to one or more other entities by the entity and a reference to an executable program. In response to execution of the executable program, one or more records of an electronic ledger in the electronic ledger platform are committed in accordance with a first protocol.

### CROSS-REFERENCE TO RELATED APPLICATIONS

This Application is related to U.S. patent application Ser. No. 17/480,980 filed on Sep. 21, 2021, the content of which is incorporated by reference herein in its entirety.

### TECHNICAL FIELD

The disclosed subject matter generally relates to multiple transfers of blockchain-based tokens.

### BACKGROUND

An electronic ledger, such as a blockchain, can be used to record ownership of assets and enable entities to carry out transactions using electronic tokens associated with those assets. For example, a token, which in itself can be a type of electronic asset, may be transferred among entities by issuing transactions recorded on a blockchain. In many electronic ledger platforms, the originator of a transaction has limited to no control over the downstream transactions and cannot participate as a beneficiary of such downstream transactions. Nor can the originator or other reseller use transaction information recorded on the electronic ledger about the downstream token exchanges in a meaningful way.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

Among other things, we describe implementations of systems and methods for enabling one or more nodes of an electronic ledger platform to carry out operations with respect to one or more records in the electronic ledger platform. The operations include receiving an indication authorized by a selling entity to transfer a token to a buying entity, the indication comprising a first quantity of cryptocurrency to be provided by the buying entity, the token comprising a record of a record of a second quantity of cryptocurrency provided to one or more other entities by the selling entity and a reference to an executable program. In response to execution of the executable program, one or more records of an electronic ledger in the electronic ledger platform are committed in accordance with a first protocol. The committed records include references to one or more of: the transfer of the token to the buying entity; a transfer of a first portion of the first quantity of the cryptocurrency to a third entity, wherein the first portion is determined based on the first quantity and the second quantity; and a transfer of a second portion of the first quantity of the cryptocurrency to the selling entity.

Implementations of the current subject matter may include, without limitation, systems and methods consistent with the above methodology and processes, including one or more features and articles that comprise a tangibly embodied machine or computer-readable medium operable to cause one or more machines (e.g., computers, processors, etc.) to result in operations disclosed herein, by way of, for example, logic code or one or more computing programs that cause one or more processors to perform one or more of the disclosed operations or functionalities. The machines may exchange data, commands or other instructions via one or more connections, including but not limited to a connection over a network.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1A illustrates an example electronic ledger environment, in accordance with one or more embodiments, wherein an electronic ledger in communication with an issuing system and an admission system may be utilized to manage ticket sales.

FIG. 1B illustrates an example electronic ledger environment, in accordance with one or more embodiments, where cryptographic demand and admission tokens may be issued, executed, assigned and revoked.

FIG. 2A is an example flow diagram illustrating a process for controlling downstream transactions in an electronic ledger, in accordance with one or more embodiments.

FIG. 2B is another example flow diagram illustrating a process for controlling downstream transactions in an electronic ledger, in accordance with one or more embodiments.

FIG. 3 is a block diagram of a computing system that may be utilized to perform one or more computer processes disclosed herein as consistent with one or more embodiments.

The figures may not be to scale in absolute or comparative terms and are intended to be exemplary. The relative placement of features and elements may have been modified for the purpose of illustrative clarity. Where practical, the same or similar reference numbers denote the same or similar or equivalent structures, features, aspects, or elements, in accordance with one or more embodiments.

### DETAILED DESCRIPTION OF EXAMPLE IMPLEMENTATIONS

In accordance with one or more embodiments, a blockchain-based system is implemented to maintain a record of issuance and exchange of an electronic token associated with an asset (e.g., an event ticket) and automatically execute a transfer of an amount of cryptocurrency to an originating entity when the token is transferred between entities in downstream exchanges occurring on an electronic ledger platform. As the token is transferred between entities, the token may be exchanged for an increasingly larger quantity of cryptocurrency.

A subsequent transfer of the token, in certain aspects, triggers an executable program (e.g., smart contract) stored on the electronic ledger which causes a portion of the cryptocurrency paid in the transfer to be provided to an upstream seller, such as the originator or the originator's agent. The blockchain-based system also maintains a record of what is provided to the originator across transactions of the same token. As such, the amount of cryptocurrency provided to the originator in subsequent transfers of the token depends on the previous transfers. In this way, the system maintains the state and information about multiple transfers of the same token.

To help better understand and appreciate the novel aspects and the practical applications of the subject matter disclosed herein, we use the example of the right of admission to a venue which has traditionally been reserved by way of, for example, an individual purchasing a physical ticket and presenting it at the time of entry to the event. With the advent of electronic ticketing technology, it has become possible to purchase an admission ticket (e.g., an e-ticket) from an online merchant. Thus, consumers can now present a digital version of a ticket instead of the traditional physical version (e.g., a printed paper ticket) to gain admission to an event.

Typically, a primary ticketing agency is chosen by an event producer or a content rights holder to manage the initial ticket sales. Thereafter, attendance rights held in the form of physical or digital tickets can generally be freely gifted, transferred, or sold by private or professional resellers at a secondary marketplace, either in person or online. Brokers and resellers (e.g., downstream resellers) often buy tickets at an initial sales price (e.g., face value) with the hope and expectation of making a profit by selling the tickets at a premium later. Usually, the downstream sales do not require the reseller to pay a commission to the event producer or the primary ticketing agency. Even if such arrangement exist, enforcing it is rather difficult or impossible. Thus, a reseller gets to keep the net proceeds from a downstream sale.

When there is high customer demand for tickets, supply and demand dictates that the attendance price for a ticket will be higher than the face value and the attendance price continues to increase incrementally with each downstream exchange, until the day of the event. When the difference between the attendance price and the ticket's face value becomes substantially large, an originating entity (e.g., a primary ticketing agency) will often compete with downstream resellers and may not release or offer as many tickets for sale to resellers. This results in less consumer choice and less efficiency in the markets because limiting the volume of tickets available through resellers can ultimately backfire and translate into a smaller total sales volume than otherwise expected or possible as fewer event tickets will be available to purchase by the consumers.

In certain circumstances, primary ticketing agencies aim to further participate in the monetary rewards of the downstream sales, particularly when they observe attendance prices at levels that exceed face values. The mechanisms that these agencies have available to do so are limited in their capabilities and harmful to the consumer experience in that they create friction for consumers to access the tickets in attending the event and/or constrict the supply of inventory. Primary ticketing agencies have conventional ticketing systems that are incapable of accurately monitoring the sales price of a ticket in downstream commerce or the rightful ownership. Further, due to the large number of professional resellers and the varying methods of sale, sometimes the economic interests of the content rights holders, primary ticketing agencies, and professional resellers in the resale marketplaces becomes misaligned. As noted earlier, this can result in less collaboration and a less efficient ecosystem for the consumers and parties involved.

In addition, some participants are unable to integrate their systems, making it impossible to ensure the correctness of the monetary basis of all transactions. Other participants are unwilling to integrate their systems or data in order to protect proprietary sales or business information from disclosure to other parties. The resulting disconnect between these systems makes it impractical to implement multi-party contracts and to monitor resale fees accurately, efficiently, and in a timely fashion.

The above shortcomings can adversely affect availability of tickets, ticket sales, profit margins, and consumer satisfaction. It is desirable to improve downstream transaction control and provide a mechanism that allows for a share of the downstream sales to be provided to upstream sellers without compromising confidential information, the ticket verification process, and the security and integrity of the electronic ticketing system as a whole.

In accordance with one or more implementations, an electronic ledger environment configured for ticketing, resale and admission rights management enables one or more entities (e.g., an originating entity or agency) to control and orchestrate functions and operations associated with the issuance, execution, pricing, commissions, transfer, assignment, or revocation of digital tokens. Different types of digital tokens (e.g., a demand token and an admission token, described below) may be implemented or instantiated to represent certain rights to buy or sell event tickets or admission to an event or venue, and also to control or determine the number of outstanding tickets that are remaining in the hands of resellers.

Using an electronic ledger platform, such as a blockchain-based transfer mechanism, can decentralize transactions, exchange sales data, and obligate multiple parties to payments, while preserving information secrecy for each party involved in the transaction chain. Thus, in some embodiments, a blockchain is used to record price and fee data in a decentralized and reliable manner, allowing sellers to transfer tickets freely while simultaneously accounting for resale fees and commissions or other transaction data or metadata.

The above operations advantageously may be performed without the direct integration of different systems and technologies used by the multiple parties involved in the transactions. This implementation results in a more robust and simple operation environment in which a mixing pool may be optionally added to obfuscate transacted business information and prevent the information from being disclosed to unauthorized parties, but ensuring that all parties ultimately trust the transactions' outcome and efficacy.

According to certain implementations and as provided in further detail below, to achieve the above-noted practical outcomes and advantages, when transferring ticket tokens on a blockchain, one or more smart contracts are used to allow a primary issuer to monitor the resale price of tickets as they are sold in downstream transaction. When a transfer of a ticket token discloses a transfer price (either explicitly or conjointly with a payment ledger entry), a commission is required to be paid to a party other than the seller (e.g., to the originator, or originators agent, or some other upstream seller) based upon the transfer price and a previous transfer price (e.g., any prior transfer price or the purchase price paid by the reseller) recorded in the blockchain.

Based on the above implementation, additional commissions (beyond any earlier or initial commissions) are paid on downstream transactions, in view of additional prices paid above the ticket's face value or based on the incremental increase in the sales price of the ticket as the ticket is being sold to downstream resellers until it is finally sold to a consumer. This additional commission can help align the interests of the content rights holders and primary issuers with the resale parties.

### Definitions

Definitions for certain terminology as applicable to one or more embodiments disclosed herein are provided below for the purpose of clarity and context but without the intention to unduly limit the scope of the claimed subject matter to any specific examples or details.

As used herein, a primary issuer is a party who first sells a particular ticket. Face value is the price paid for a ticket upon initial sale. Transfer price is the price paid for a ticket upon initial sale or a subsequent sale. Attendance price is the price paid by the party who attends the event. Resale commission is a commission paid upon resale of a ticket.

A token refers to a digital asset representing ownership or other interest rights. In this context and as provided in further detail below, a token may be transferred between parties who may have an interest in buying, selling or transferring admission rights to an event or venue. A content rights holder refers to one or more producers of an event, who initially own and control the rights to attend the event or venue. In this context, admission or admitting refers to the act of allowing one or more people to attend an event by validating their right to attend.

A demand token refers to a token representing the right to demand an asset from another party. In this context, a demand token may represent ownership rights and more particularly the right to demand a ticket, ticket token, or admission token from one or more parties or entities participating in a token exchange. An admission token, in contrast, may be a token that represents the right to attend an event. An admission token essentially would be the digital equivalent to a printed ticket. A ticket, as used herein, may refer to either a demand token or an admission token.

An admission token is a bearer instrument that allows admission to an event, a venue, and in some circumstances may also represent the right to attend or own a tangible or non-tangible asset, whether fungible or non-fungible. A demand token is a digital token representing the ownership of a ticket. A zone ticket refers to the obligation for a seller to provide a ticket to a buyer in a certain section or with certain qualities. Seat license rights refer to the rights to purchase tickets for an event.

Originator or originating entity refers to the owners or producers of an event (or media) who offer the tickets and the related tokens for sale to either (1) the public (e.g., the consumers) or (2) resellers (e.g., those who intend to resell the tickets) to the public, for example, over an electronic ledger platform or other online environment. Originating agent refers to an agent (e.g., an exclusively contracted ticket agency) of the owners or producers who offer the tickets and the related tokens for sale to the public or resellers.

The terms “upstream,” “midstream,” and “downstream” refer to points in time when a ticket or token is exchanged or sold. Within the context of the sale of a ticket in the stream of commerce, an upstream entity is a party who sells a ticket to a midstream entity, who in turn resells the ticket to a downstream entity. Depending on the nature of the transaction and the point in time within a designated or observed timeline, an entity may be considered to be an upstream, midstream, or downstream seller (or buyer) in relation to other entities in the exchange.

In certain embodiments, an electronic ledger is used to record a list of changes to a set of data that represent purchases of items, transfers of ownership, or any other changes in data records. A digital signature of a data record may be a cryptographic technique that allows a verifying entity to strongly trust that the data record was generated or certified by a specific party. A digital signature may be applied to individual data records or collections of records, in certain implementations.

A distributed electronic ledger as used herein refers to an electronic ledger where different parts of the ledger are stored in different systems, often but not necessarily owned by different parties. A distributed ledger may be partitioned by record, by field, or a combination of the two. A blockchain may be a transactional or distributed ledger trusted by digital signatures that certify the content and/or sequence within the ledger. Individual records may also be certified through digital signatures by other parties. Although “blockchain” and “electronic ledger” are sometimes used interchangeably in this description, a blockchain is just one type of electronic ledger, and the techniques described here can be used just as effectively with other types of electronic ledgers.

Consensus refers to a mechanism or protocol that allows multiple parties to agree on the content of a block in a blockchain or distributed ledger. Proof of Work and Proof of Stake are examples of consensus mechanisms that may be utilized in accordance with one or more embodiments to verify transactions on a blockchain.

One or more electronic ledgers may be implemented to include or interface with smart contracts in the form of computing engines. A smart contract may be an executable program with a set of business logic that governs valid entries in an electronic ledger. In some embodiments, a smart contract may be registered or distributed within a blockchain, multi-chain or any type of electronic ledger, so that participants can validate or execute steps defined in the contract.

A smart contract may be utilized to, for example, allow the performance of credible (e.g., trackable and irreversible) transactions without involving a centralized managing party. The transactions may be processed by serverless microservice engines (e.g., Lambdas or other decentralized infrastructure) on a distributed ledger platform. To enable financial transactions, in certain embodiments, tokens (e.g., personal trading units) are utilized to monetize digital transactions without the need for a centralized institution (e.g., a bank).

In some example embodiments, a smart contract is a digital promise entailing rights and duties voluntarily agreed by the parties to a contract configured to digitally facilitate, verify, or enforce the negotiation or performance of an agreement between the parties. In one embodiment, the smart contract may is implemented based on a combination of protocols with user interfaces to formalize and secure relationships over computer networks, using cryptographic and other security mechanisms.

A consistent audit trail of transactions, exchanges and activities may be maintained by way of using an electronic ledger, which may be implemented as a publicly accessible message queue with an immutable database. Examples of computing platforms that may be used to implement a distributed ledger may include a blockchain, a hashgraph, or other computing data structures implemented based on a growing list of N associated records or data blocks in a blockchain.

A data block may be logically linked to another block (e.g., a previous block) in a distributed ledger based on a cryptographic hash of the content of the other block. A data block may also include a timestamp or transaction data. Further, a data block in a distributed ledger may be implemented to be immutable (e.g., resistant to modification of the data stored within the block). The immutable nature of the data block and the acceptance of a set of rules and policies by the users (or the implementers) of the distributed ledger platform provides for high levels of confidence in the data stored and processed by the distributed ledger because a singular central entity is not solely in control.

### Example Implementations

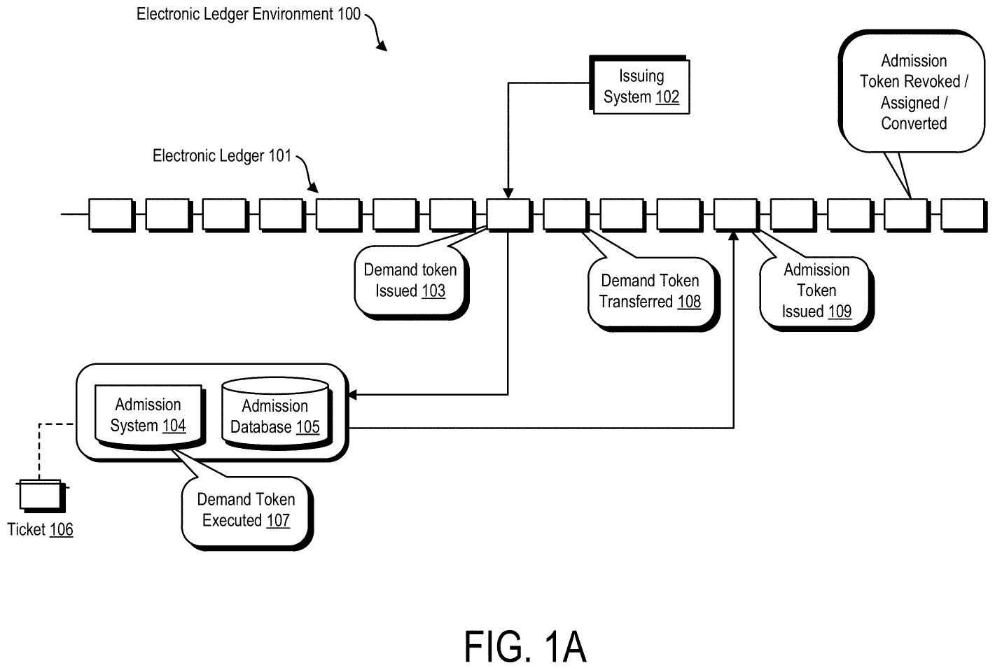

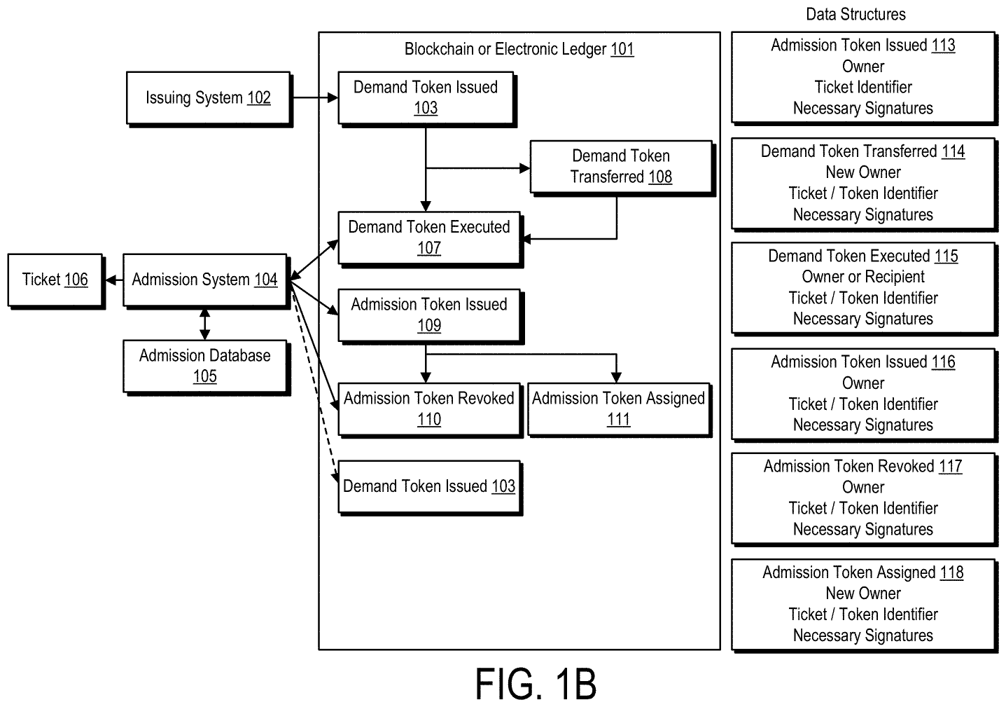

Referring to FIG. 1A, an electronic ledger environment 100 may be implemented as an immutable mechanism for ticket issuance and transaction flow management in which parties involved in issuing and executing electronic tickets may write and read data and instructions associated with one or more processes using an electronic ledger 101. The electronic ledger 101 may provide the infrastructure in which the parties that manage the ticketing process may communicate by writing to block addresses designated to the parties engaged in the process.

As shown, the example electronic ledger 101 includes a plurality of linked data blocks. The electronic ledger 101 may be communicatively connected or coupled to issuing system 102 and admission system 104 configured to respectively issue and execute one or more digital tokens, such as a demand token. A user may interact with the issuing system 102, by way of a user interface mechanism for example, to request a demand token to be issued.

The process model for the electronic ledger 101 may define parameters and constraints associated with the manner in which token data is to be utilized or manipulated. For example, in certain embodiments, the rules for managing the demand and admission tokens may provide for the following:
A demand token to be recorded on the electronic ledger 101.
The demand token to be freely transferred on the electronic ledger 101 subject to any smart contracts.
The demand token to be executed to request an admission token.
An admission token to not be transferable on the electronic ledger 101.
An admission token to be exchangeable for a demand token.
Admission tokens to be stored or redeemed either on the electronic ledger 101 or in another system (e.g., an event provider's point of sale system).

Referring to FIGS. 1A and 1B, the process for managing demand tokens and admission tokens may be implemented by enabling one or more nodes of an electronic ledger 101 to carry out operations with respect to one or more records in the electronic ledger 101. These operations, in one example, include the electronic ledger 101 receiving an indication to exchange a first token of a first type (e.g., a demand token) with a second token of a second type (e.g., an admission token). The indication received as authorized by a first entity (e.g., a seller or owner of an event ticket, an originator or an agent of the originator) allows for the exchange of the first token with the second token.

The first token, in some aspects, is associated with ownership information that indicates the first token is owned by the first entity. The first token may also include activity information (e.g., data or metadata) about a first activity, such as a concert to be held at a certain date and time and commission and pricing details. The ownership of the first token is transferable to other entities (e.g., buyers, resellers, or the general consumer public) over the electronic ledger environment 100 according to the ownership information associated with the first token as provided in further detail below.

In accordance with one or more aspects, the electronic ledger 101, in response to receiving an indication to exchange the tokens, generates the second token, which is associated with the ownership information and may also include admission information. The ownership information indicates that the second token is owned by the first entity. The admission information indicates that the second entity is to be admitted to or allowed to participate in the first activity.

Without limitation and by way of example, in some embodiments, the generation of the admission token may be committed to one or more database records of a legacy system, or records in an electronic ledger environment 100 (e.g., an electronic ledger platform), in accordance with a one or more protocols. The protocols control and memorialize the downstream exchange of the tokens and the related transactions among multiple parties and are configured to commit the tokenized transactions to at least a blockchain or an electronic ledger 101, as provided in further detail below.

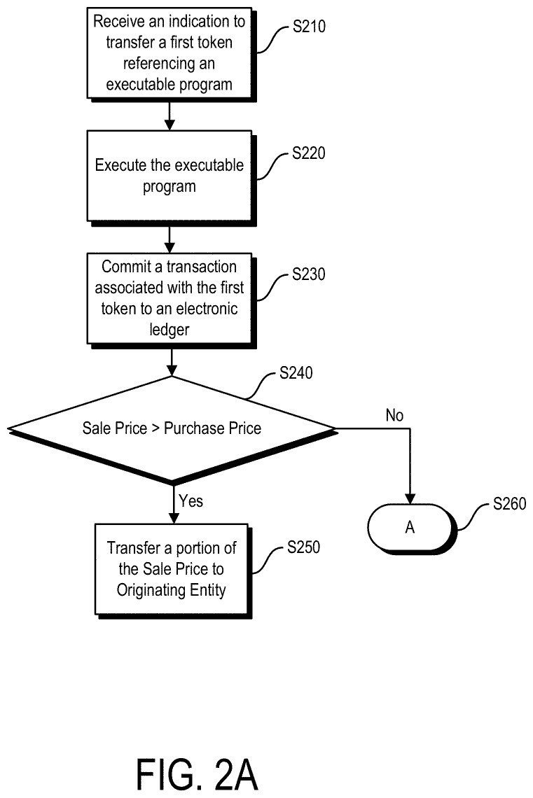

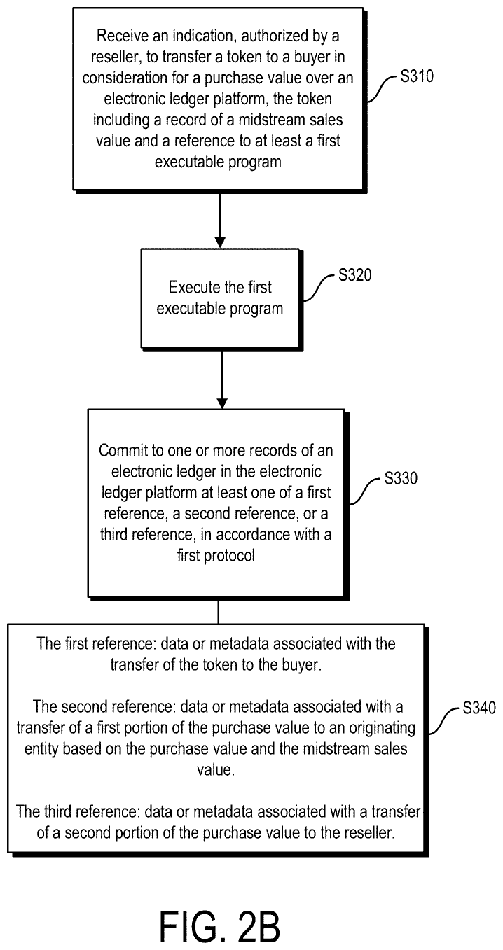

Referring to FIG. 2A, in one example embodiment, one or more nodes of an electronic ledger 101 carry out operations with respect to one or more records of the electronic ledger 101 in order to enable tokenized transactions involving the purchase and sale of intangible or tangible items (e.g., event tickets). The transactions may involve multiple parties. By way of a non-limiting example, when an originating entity, such as an event or media producer (or an agency associated with the event or media producer), desires to sell tickets for an event, the electronic ledger environment 100 may be used to track the sales of tickets from the originating entity to the downstream resellers and ultimately the consumers.

The tracking may be performed by way of recording in the electronic ledger 101 records unique identification information and metadata associated with a cryptographic token (e.g., an admission token, or a demand token) that provides the right of admission to the event. In certain embodiments, the downstream resellers automatically pay a commission on a downstream sale due to the transacted cryptographic token being associated with an executable program (e.g., a smart contract stored on the electronic ledger 101) configured to calculate a commission value to be paid to an identified upstream seller (e.g., the originating entity or an agent of the originating entity).

In one example scenario, when a transaction is initiated between a seller and a buyer, the electronic ledger 101 receives an indication authorized by the selling entity to transfer a cryptographic event token (e.g., an electronic ticket) to a buying entity. When the transaction is approved, the transaction details (e.g., ticket price, identity of the seller, identity of the buyer, unique ticket ID, etc.) may be recorded in the electronic ledger 101. As noted, in addition to the transaction details, a reference to an executable program may also be registered with the admission or demand token to calculate a commission to be paid to an upstream seller by a downstream reseller, as provided in further detail below.

Notably, when a transaction is the first transaction in the chain of transactions associated with a particular token, the selling entity is typically the originating entity. In such a transaction, the buying entity may be either a downstream reseller (e.g., an entity who intends to resell the token) or a consumer (e.g., an individual who intends to attend the event). In one example implementation, in an initial sale transaction involving the sale of a tokenized ticket over the electronic ledger 101, no commission is paid to any of the entities involved in the transaction. Therefore, an executable program associated with the token being exchanged is either not executed or, if executed, returns a null or zero value indicating no commission is to be paid.

Now referring to FIG. 2A, consider another example scenario in which the selling entity is a reseller and the buying entity is either another downstream reseller or a consumer. For the token to be transferred to the buying entity, the electronic ledger 101 receives an indication from the selling entity to transfer a token to the buying entity, where the token references an executable program (S210).

In one example embodiment, the indication references a first quantity of cryptocurrency associated with a purchase price (e.g., 0.005 BTC) paid to the selling entity by the buying entity in exchange for the token. In some examples, the token being transacted is associated with a record of a second quantity of cryptocurrency (e.g., 0.004 BTC) reflecting consideration paid to one or more other entities (e.g., upstream resellers) by the selling entity at an earlier time in exchange for the transfer of the token to the selling entity.

As a part of the processing of the token exchange between the selling entity and the buying entity, one or more nodes in the electronic ledger 101 execute an executable program (e.g., a smart contract) referenced by the token (S220). In response to the execution of the executable program, information about the transaction associated with the sold token is committed to at least one record of the electronic ledger 101 in accordance with a token transfer protocol (S230). The transaction information may include data or metadata about one or more of the following:
the transfer of the token to the buying entity,
the transfer of a first portion (e.g., a commission) of the first quantity of the cryptocurrency to a third entity (e.g., the originating entity or any upstream entity involved in a prior sale of the same token), and
the transfer of a second portion (e.g., net sale proceeds after commission) of the first quantity of the cryptocurrency to the selling entity.

The commission amount, depending on implementation, may be determined based on the first quantity and the second quantity of the cryptocurrency. By way of example, if the reseller sells a demand token or an admission token to a downstream buyer for 0.005 BTC (e.g., sales price or the first quantity of cryptocurrency) but had purchased the demand token or the admission token from the originating entity or an upstream seller for 0.004 BTC (e.g., purchase price or the second quantity of cryptocurrency), then a calculated commission paid to the upstream buyer may be based on a percentage of the difference between the 0.005 BTC and 0.004 BTC (e.g., x % of 0.001 BTC).

It may first be determined whether the sales price is greater than the purchase price (S240) because a reseller, at least in one example embodiment, should not have to pay a commission if the reseller broke even or incurred a loss when selling the token. If the reseller generated a profit, however, then a portion of the sales price (e.g., a commission) is paid to the originating entity or other upstream seller (S250) due to the automatic execution of the executable program or smart contract stored on the electronic ledger 101. The records of the electronic ledger 101 may be updated to indicate that a transaction did not result in a profit and, depending on implementation, the executable program may either not be executed or may return a zero or null value to indicate no commission is due (S260).

In addition to the above noted data and metadata stored and processed in the electronic ledger environment 100, in certain embodiments, a token involved in the electronic ledger transaction may further include a reference or information about a third quantity of cryptocurrency (e.g., 0.002 BTC) representing the face value of an event ticket as issued by an originating entity. In this context, the face value would be the amount of cryptocurrency paid by an upstream reseller to, for example, a originating ticket sales agency upon an initial transfer of the token from the originating entity to an upstream reseller. Depending on implementation, the face value of the ticket may be also taken into consideration as a factor in calculation of commissions by the executable program in downstream transactions.

Referring to FIG. 2B, in another example embodiment, one or more nodes of an electronic ledger 101 may be configured to carry out operations to transfer a cryptographic token between multiple entities, such as an originating entity, a reselling entity (reseller), and a buying entity (buyer), for example. An indication authorized by the reseller is received by a node in the electronic ledger 101 to transfer the token to the buyer in consideration for a purchase value (e.g., 0.005 BTC) over the electronic ledger platform (S310). The purchase value may be in any denomination of currency, including cryptocurrency, such as Bitcoin (BTC), Ethereum (ETH) or other tradable currency that can be exchanged over the electronic ledger 101.

In some aspects, the first cryptographic token includes a record of a midstream sales value (e.g., 0.004 BTC) provided by the reseller to the originating entity in consideration for transfer of the first cryptographic token to the reseller (not shown in FIG. 2B). The first cryptographic token may also include a reference to at least a first executable program. In response to the execution of the first executable program (S320), at least one of a first reference, a second reference, or a third reference are committed to one or more records of the electronic ledger 101 in accordance with a first protocol configured to verify and settle cryptocurrency transactions on the electronic ledger platform (S330).

Depending on implementation, by way of example and without limitation, the first reference includes data or metadata associated with the transfer of the first cryptographic token to the buyer in exchange for the purchase value (e.g., 0.005 BTC) paid by the buyer to the reseller. The second reference includes data or metadata associated with the transfer of a first portion of the purchase value (e.g., a commission) to the originating entity, where the commission is determined based on the purchase value and the midstream sales value (e.g., a percentage of the difference between 0.005 BTC and 0.004 BTC). The third reference may include data or metadata associated with the transfer of a second portion of the purchase value (e.g., net profits) to the reseller.

In the above example, if the reseller purchased the token for 0.004 BTC from the originating entity and sold it to the buyer for a midstream sales value of 0.005 BTC, then the gross proceeds to the reseller would be the midstream sales value minus purchase value (0.005 BTC-0.004 BTC), which is 0.001 BTC. Assuming an example 10% commission rate, the commission value payable to the originating party is calculated as 0.0001 BTC with a net payment of (0.005 BTC-0.0001 BTC) 0.0049 BTC payable to the reseller.

In another example, instead of cryptocurrency other denominations of currency, such as the United States Dollar, can be used to make the transaction on the electronic ledger. For example, if the reseller purchased the token for $150 from an upstream seller and sold the token to a downstream buyer for a sales value of $200, then the profit to the reseller is the sales value minus purchase value ($200-$150), which is $50 in this example. Assuming a 10% commission rate on the profit of $50, for example, the commission value payable to an upstream seller is calculated as $5 with a final amount of ($50-$5) $45 payable to the reseller.

For a token transaction to be successful, in certain aspects, the transaction or an indication received by the electronic ledger 101 for making a payment may need to be authorized by both the selling entity and the buying entity. Furthermore, a transaction associated with the transfer of the token to the buying entity may be committed in a first record of the electronic ledger 101 and the transfer of the commission amount to a designated entity may be committed in a second record of the electronic ledger. In alternative embodiments, the transaction data may be recorded in a single record of the electronic ledger for a single transaction.

As provided in the above examples, the calculation of the commission, in certain implementations, is such that the originating entity (or an upstream seller) determines the amount of commission to be collected by the executable program for each incremental downstream transaction. For example, the commission paid may be a fixed value (e.g., $10 per transaction) regardless of the value of the token transactions, or gross profits or net profits of the reseller. Alternatively, the commission paid may be a percentage of the difference between the amount paid by a reseller in purchasing the token and the amount received by the reseller when selling the token and optionally taking into account certain other factors, such as the face value of the ticket or the general state of ticket sales.

In one or more implementations, multiple executable programs (e.g., multiple smart contracts) are associated with the same token, such that a first upstream seller receives a first commission for a downstream sale, and a second upstream seller receives a second commission from the same downstream sale. In such a scenario, a downstream seller would automatically pay from the amount collected, in exchange for the sale of a token, a first commission to the first upstream seller upon execution of the first executable program, and also pay a second commission to the second upstream seller upon the execution of the second executable program.

It is noteworthy that, in certain embodiments, one or more executable programs associated with the token being transacted are executed for every downstream transaction involving the token. In other words, an upstream seller to which a commission is due (e.g., as a result of the execution of a smart contract) will receive a commission on the incremental increase in the sales price of a ticket being sold in the downstream commerce until the final sale. Certain rules, conditions, and factors may be interjected into one or more executable programs to adjust or manipulate the amount of commission due on one or more downstream transactions.

In one example scenario, a first smart contract may be executed to govern a ticket transaction between a reseller and a consumer as well as to govern a commission transaction between the reseller and an upstream seller. In another example scenario, a second smart contract may be executed to govern the commission transaction between the reseller and an upstream seller for the same or other ticket transactions. In other words, a single or multiple smart contracts and electronic ledger records may be utilized to govern various aspects of a ticket sale or different transactions associated with a ticket sale in either upstream or downstream directions.

For example, an upstream seller may want to control or dynamically adjust the amount of commission due based on the downstream sales price, or based on the downstream profit made by a reseller prior to the payment of the commission. By way of a non-limiting example, an upstream reseller may configure the executable program to result in the collection of an X % (e.g., 5%) commission, if the downstream pre-commission profit made by a downstream reseller is under a first value (e.g., $25), and the collection of a Y % (e.g., 10%) commission, if the downstream pre-commission profit is over the first value but less than a second value (e.g., $50), and the collection of a Z % (e.g., 15%) commission, if the pre-commission profit is over the second value, and so on.

Similarly, the commission amount may be waived or set to a nominal value, if the pre-commission profit made by the downstream seller is, for example, zero or below a certain threshold value. Other possible implementations and configurations for a fair or reasonable commission calculation protocol may be enforced in various embodiments. As another example, the executable program for commission calculation may be configured to take into consideration the status of a downstream seller or buyer. For example, if the reseller or consumer falls in a certain category such as a protected class, a minority group, individuals with limited financial resources (e.g., students), or individuals of a certain age or disability, then amount of commission may be adjusted lower or waived.

Accordingly, various aspects and implementations of the claimed subject matter allow an upstream seller to have an adjustable level of control over the amount of commission paid by downstream resellers. The commission imposed may be in perpetuity or terminable after a certain number of transactions on the electronic ledger 101 or may be based on configurable factors and conditions that may be adjusted overtime as the timeline for attending or producing an event expires.

For example, the smart contracts or executable programs on the electronic ledger 101 may be configurable to reduce the amount of commission due if attendance for an event is projected to be lower than a first threshold at a first timeline (e.g., low demand), or alternatively may increase the amount of commission due if attendance to an event is projected to be higher than a second threshold at a second timeline (high demand), where the adjustments may be made incrementally over time and/or in real time as information about attendance is collected or becomes available.

By way of example and without limitation, the collected commission percentage for an event may be reduced by 1% (or $1) every 24 hours (or after every transaction), in response to determining that 90 days prior to the event less than 20% of the tickets (e.g., seats) are sold. And/or, the collected commission percentage for the same event may be increased by 1% (or $1) every 24 hours (or after every transaction), in response to determining that 30 days prior to the event less than 20% of the tickets are outstanding or remain available.

In certain implementation, the status of a ticket holder can be predicted by determining whether the current token owner is a consumer who plans to attend the event. For example, if the token owner has converted his demand token to an admission token then it is likely that the token owner will be attending the event and does intend to resell the ticket token. Conversely, a token owner may be assumed to be a reseller, if the token owner has not converted his demand token to an admission token. Using statistical analysis, the commission values for downstream transactions may be adjusted, depending on the number of current token owners that are identified as having a consumer or reseller status.

By way of example and without limitation, if it is determined that more than 25% of the current token owners are resellers, then the commission due on the sale of a demand token may be reduced to promote further ticket sales to consumers, where the statistical analysis of the status of the token owners reflects low attendance demand for the event. Alternatively, if it is determined that less than 25% of the current token owners are resellers, then it can be assumed that there is high demand for attending the event, and the commission due on the sale of a demand token may be increased to maximize return and profit margin to the upstream sellers (e.g., the originating ticket agency, originating entity or producer).

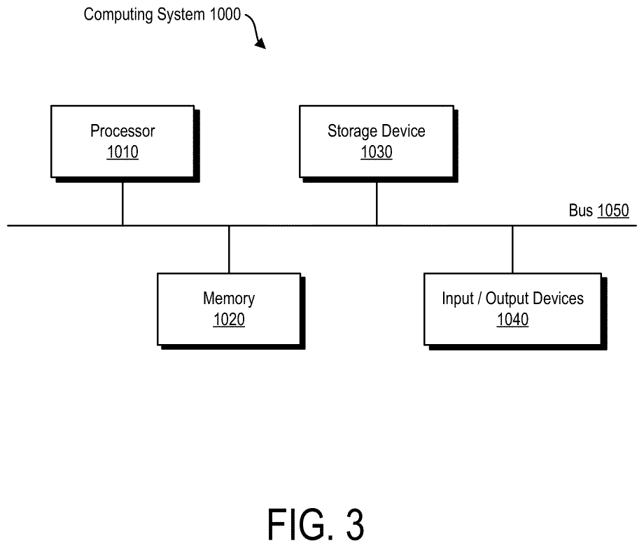

Referring to FIG. 3, a block diagram illustrating a computing system 1000 consistent with one or more embodiments is provided. The computing system 1000 may be used to implement or support one or more platforms, infrastructures or computing devices or computing components that may be utilized, in example embodiments, to instantiate, implement, execute or embody the methodologies disclosed herein in a computing environment using, for example, one or more processors or controllers, as provided below.

As shown in FIG. 3, the computing system 1000 can include a processor 1010, a memory 1020, a storage device 1030, and input/output devices 1040. The processor 1010, the memory 1020, the storage device 1030, and the input/output devices 1040 can be interconnected via a system bus 1050. The processor 1010 is capable of processing instructions for execution within the computing system 1000. Such executed instructions can implement one or more components of, for example, a cloud platform. In some implementations of the current subject matter, the processor 1010 can be a single-threaded processor. Alternately, the processor 1010 can be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 can store data structures representing configuration object databases, for example. The storage device 1030 is capable of providing persistent storage for the computing system 1000. The storage device 1030 can be a floppy disk device, a hard disk device, an optical disk device, or a tape device, or other suitable persistent storage means. The input/output device 1040 provides input/output operations for the computing system 1000. In some implementations of the current subject matter, the input/output device 1040 includes a keyboard and/or pointing device. In various implementations, the input/output device 1040 includes a display unit for displaying graphical user interfaces.

According to some implementations of the current subject matter, the input/output device 1040 can provide input/output operations for a network device. For example, the input/output device 1040 can include Ethernet ports or other networking ports to communicate with one or more wired and/or wireless networks (e.g., a local area network (LAN), a wide area network (WAN), the Internet).

In some implementations of the current subject matter, the computing system 1000 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1040. The user interface can be generated and presented to a user by the computing system 1000 (e.g., on a computer screen monitor, etc.).

One or more aspects or features of the subject matter disclosed or claimed herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that may be executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server may be remote from each other and may interact through a communication network. The relationship of client and server arises by virtue of computer programs running on the respective computers and having a client-server relationship to each other.

These computer programs, which may also be referred to as programs, software, software applications, applications, components, or code, may include machine instructions for a programmable controller, processor, microprocessor or other computing or computerized architecture, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal.

The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

1. A method of enabling one or more nodes of an electronic ledger platform to carry out operations with respect to one or more records of the electronic ledger platform, the operations comprising:
receiving an indication authorized by a selling entity to transfer a token to a buying entity, the indication comprising a first quantity of cryptocurrency to be provided by the buying entity,
the token comprising a record of a record of a second quantity of cryptocurrency provided to one or more other entities by the selling entity and a reference to an executable program; and
in response to execution of the executable program, committing to one or more records of an electronic ledger in the electronic ledger platform in accordance with a first protocol:
the transfer of the token to the buying entity;
a transfer of a first portion of the first quantity of the cryptocurrency to a third entity, wherein the first portion is determined based on the first quantity and the second quantity; and
a transfer of a second portion of the first quantity of the cryptocurrency to the selling entity.

2. The method of claim 1, wherein the token further comprises a third quantity of cryptocurrency provided to the third entity upon an initial transfer of the token.

3. The method of claim 1, wherein the indication is also authorized by the buying entity.

4. The method of claim 1, wherein the first portion is determined based on a percentage of a difference between the second quantity and the first quantity.

5. The method of claim 1, wherein the transfer of the token to the buying entity is committed in a first record of the electronic ledger.

6. The method of claim 1, wherein the transfer of the first portion of the first quantity of the cryptocurrency to the third entity is committed in a second record of the electronic ledger.

7. The method of claim 1, wherein the transfer of the token to the buying entity and the transfer of the first portion of the first quantity of the cryptocurrency to the third entity are committed in a first record of the electronic ledger.

8. The method of claim 3, wherein the third entity determines a value associated with the percentage.

9. The method of claim 1, wherein the third entity determines a value associated with the first portion.

10. The method of claim 1, wherein value of the first portion is zero, in response to determining that the difference between the second quantity and the first quantity is less than a predetermined threshold.

11. The method of claim 1, wherein value of the first portion is less than or equal to a first threshold, in response to determining that the difference between the second quantity and the first quantity is less than a second predetermined threshold.

12. A method of enabling one or more nodes of an electronic ledger platform to carry out operations with respect to one or more records of the electronic ledger platform, the one or more records configured to memorialize ownership rights of a cryptographic token as transferred between multiple entities, including a first entity, a second entity, and a third entity, wherein a first quantity of currency represents an initial value assigned to the cryptographic token, the operations comprising:
receiving an indication authorized by the second entity to transfer the first cryptographic token to the third entity in consideration for a third quantity of currency over the electronic ledger platform,
the first cryptographic token comprising a record of the first quantity of currency, a record of a second quantity of currency provided in consideration for transfer of the first cryptographic token to the second entity, and a reference to at least one of a first executable program or a second executable program or both; and
in response to execution of the first executable program, committing to one or more records of an electronic ledger in the electronic ledger platform in accordance with a first protocol:
the transfer of the first cryptographic token to the third entity;
a transfer of a first portion of the third quantity of currency to the first entity, wherein the first portion is determined based on the third quantity of currency and the second quantity of currency; and
a transfer of a second portion of the third quantity of currency to the second entity.

13. The method of claim 11, wherein the first value is assigned by the first entity.

14. The method of claim 11, wherein the one or more records of the electronic ledger further include:
a transfer of a third portion of the third quantity of currency to a fourth entity, in response to execution of the second executable program.

15. A method of enabling one or more nodes of an electronic ledger platform to carry out operations with respect to one or more records of the electronic ledger platform configured to transfer a cryptographic token between multiple entities, including an originating entity, a reseller, and a buyer, the operations comprising:
receiving an indication authorized by the reseller to transfer the first cryptographic token to the buyer in consideration for a purchase value over the electronic ledger platform,
the first cryptographic token comprising a record of a midstream sales value provided by the reseller to the originating entity in consideration for transfer of the first cryptographic token to the reseller, and a reference to at least a first executable program; and
in response to execution of the first executable program, committing to one or more records of an electronic ledger in the electronic ledger platform at least one of a first reference, a second reference, or a third reference, in accordance with a first protocol.

16. The method of claim 15, wherein the first reference comprises data or metadata associated with the transfer of the first cryptographic token to the buyer.

17. The method of claim 15, wherein the second reference comprises data or metadata associated with a transfer of a first portion of the purchase value to the originating entity, the first portion being determined based on the purchase value and the midstream sales value.

18. The method of claim 15, wherein the third reference comprises data or metadata associated with a transfer of a second portion of the purchase value to the reseller.

19. A computer-implemented system comprising:
at least one programmable processor; and
a non-transitory machine-readable medium storing instructions that, when executed by the at least one programmable processor, cause the at least one programmable processor to perform operations comprising:
receiving an indication authorized by the reseller to transfer the first cryptographic token to a buyer in consideration for a purchase value over the electronic ledger platform, the first cryptographic token comprising a record of a midstream sales value provided by the reseller to the originating entity in consideration for transfer of the first cryptographic token to the reseller, and a reference to at least one of a first executable program or a second executable program or both; and
in response to execution of the first executable program, committing to one or more records of an electronic ledger in the electronic ledger platform in accordance with a first protocol:
the transfer of the first cryptographic token to the buyer;
a transfer of a first portion of the purchase value to the originating entity, wherein the first portion is determined based on the purchase value and the midstream sales value; and
a transfer of a second portion of the purchase value to the reseller.

20. A computer program product comprising a non-transitory machine-readable medium storing instructions that, when executed by at least one programmable processor, cause the at least one programmable processor to perform operations comprising:
receiving an indication authorized by the reseller to transfer the first cryptographic token to a buyer in consideration for a purchase value over the electronic ledger platform,
the first cryptographic token comprising a record of a midstream sales value provided by the reseller to the originating entity in consideration for transfer of the first cryptographic token to the reseller, and a reference to at least one of a first executable program or a second executable program or both; and
in response to execution of the first executable program, committing to one or more records of an electronic ledger in the electronic ledger platform in accordance with a first protocol:
the transfer of the first cryptographic token to the buyer;
a transfer of a first portion of the purchase value to the originating entity, wherein the first portion is determined based on the purchase value and the midstream sales value; and
a transfer of a second portion of the purchase value to the reseller.
